(19) United States
(12) Patent Application Publication
(10) Pub. No.: US 2012/0230046 A1
(43) Pub. Date: Sep. 13, 2012

(54) VEHICULAR ILLUMINATION SYSTEM

(75) Inventors: Lawrence M. RICE, Hillsboro, NH (US); Thomas TESSNOW, Weare, NH (US); Howard ENG, Hancock, NH (US); Ronald E. BOYD, JR., Chichester, NH (US)

(73) Assignee: OSRAM SYLVANIA INC., Danvers, MA (US)

(21) Appl. No.: 13/043,440

(22) Filed: Mar. 8, 2011

(51) Int. Cl. B60Q 1/04

(52) U.S. Cl. 362/538

(57) ABSTRACT

A vehicle illumination system (12) having at least one light projector system (16) includes at least one light engine (24), at least one reflector (36), and a plurality of discrete light lenses (14a-n) separated by a generally opaque border (44). The light engine (24) is configured to emit light (L) which is reflected by an associated reflector (36) through an associated plurality of discrete light lenses (14a-n) and generally not through the border (44). As such, light (L) from the light engine (24) is emitted from a plurality of discrete light lenses (14a-n), thereby providing a visual appearance of multiple, individual light engines (i.e., the projector apparatus has the appearance of having an individual light engine associated with each light source emitted from the projector system) without the complexities associated with having multiple, individual light engines.

### CROSS REFERENCE TO RELATED APPLICATIONS

N/A

### TECHNICAL FIELD

The present disclosure relates to illumination systems, and more particularly pertains to illumination systems and methods for providing the appearance of multiple discrete light sources.

### BACKGROUND

Vehicle lights (for example headlights) are designed not only as illumination sources, but also as aesthetic features of the vehicle. Recently, light emitting diodes (LEDs) have become increasingly popular, for example, see U.S. Pat. Nos. 7,621,667 and 7,621,667 to Behr et al. In particular, some vehicles have headlights and/or taillights having multiple LEDs which function as discrete light sources, for example, see U.S. Pat. No. 6,796,695 to Natsume. While these multiple, discrete LED headlights are aesthetically pleasing, they heretofore have suffered from several difficulties. For example, the use of a LED to form each individual, discrete light source results increased cost due to the number of LEDs required (for example, but not limited to, ten LEDs for each headlight). The large number of required LEDs also increases the amount of heat generated, thus necessitating one or more fans, air ducts, and the like to ensure that the operating temperature of the LEDs is maintained within an acceptable range. Consequently, numerous components are necessary which results in a very expensive and complex headlight which requires tight manufacturing tolerances to properly aim the multiple, discrete light sources.

### BRIEF DESCRIPTION OF THE DRAWINGS

Features and advantage of the claimed subject matter will be apparent from the following description of embodiments consistent therewith, which description should be considered in conjunction with the accompanying drawings, wherein:

FIG. 1 illustrates one embodiment of vehicle having an illumination system consistent with the present disclosure;

FIG. 2 illustrates another embodiment of vehicle having an illumination system consistent with the present disclosure;

FIG. 3 illustrates a block diagram of one embodiment of an illumination system consistent with the present disclosure;

FIG. 4 illustrates a cross-sectional view of one embodiment of projector system consistent with the present disclosure;

FIG. 5 illustrates a front perspective view of another embodiment of projector system consistent with the present disclosure;

FIG. 6 illustrates a top perspective view of the projector system of FIG. 5 consistent with the present disclosure;

FIGS. 7-10 illustrate predicted simulation results of one embodiment of an illumination system consistent with the present disclosure.

### DETAILED DESCRIPTION

By way of an overview, one aspect consistent with the present disclosure may feature a vehicle illumination system having at least one light projector system. The projector system includes at least one light engine, at least one reflector, and a plurality of discrete light lenses. Each light engine is configured to emit light which is reflected by an associated reflector through an associated plurality of discrete light lenses. As such, light from a single light engine is emitted from a plurality of discrete light lenses, thereby providing a visual appearance of multiple, individual light engines (i.e., the projector apparatus has the appearance of having an individual light engine associated with each light source emitted from the projector system) without the complexities associated with having multiple, individual light engines.

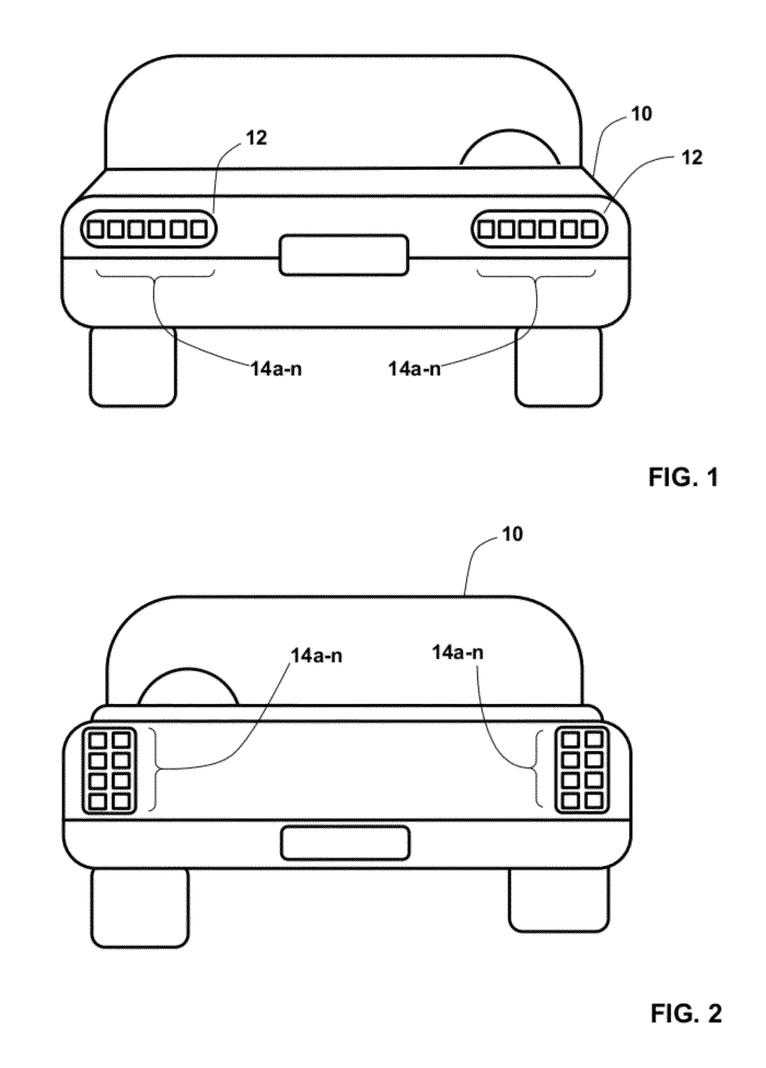

Referring to FIGS. 1 and 2, the front and rear of a vehicle 10, respectively, is generally illustrated. The vehicle 10 (such as, but not limited to, a car, truck, or the like) include one or more illumination systems 12a-n. One or more of the illumination systems 12a-n may include a headlight, fog light, running light, parking light, turn signal, brake light, backup light, or the like. The each illumination system 12a-n (also referred to herein as illumination system 12) may feature a plurality of discrete light lenses 14a-n.

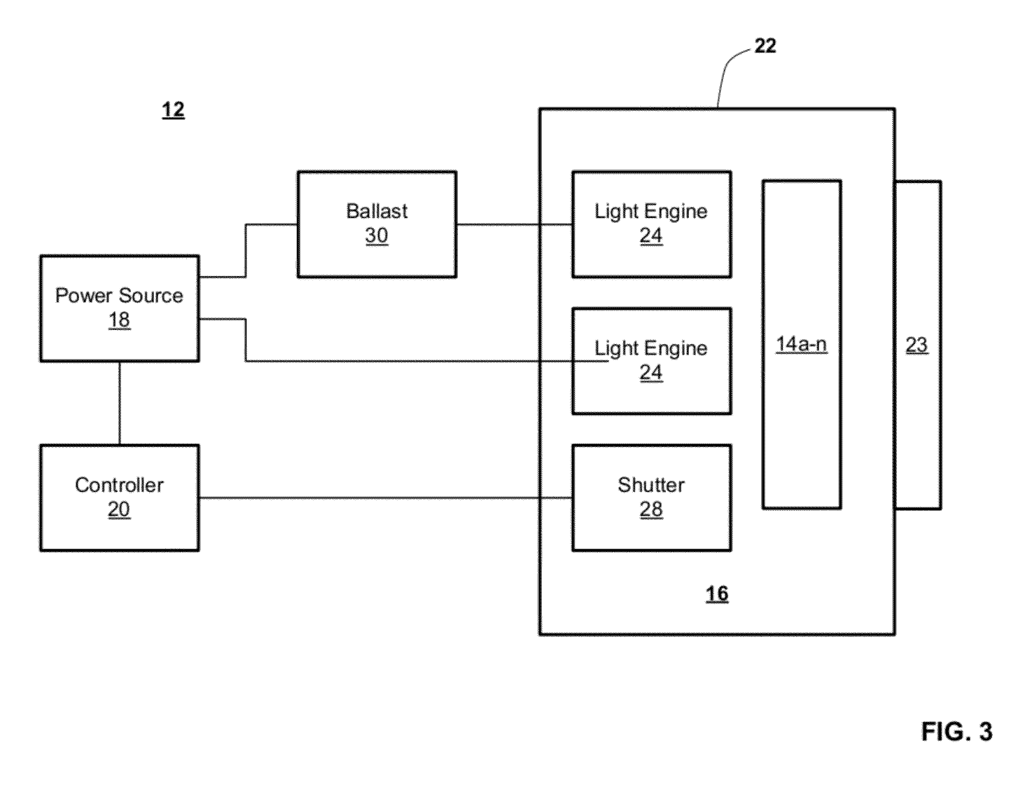

Turning now to FIG. 3, a block diagram illustrating one exemplary embodiment of an illumination system 12 consistent with the present disclosure is generally illustrated. The illumination system 12 may comprise at least one projector system 16, a power source 18, and a controller 20. The projector system 16 may comprise a housing 22, at least one light engine 24, a plurality of discrete light lenses 14a-n, and optionally a shutter 28. The housing 22 may be configured to receive at least a portion of the light engine 24, the plurality of discrete light lenses 14, and/or the shutter 28. The housing 22 may optionally include one or more outer lenses 23 as discussed herein.

The projector system 16 may receive an electrical input from the power source 18, for example, to energize the light engine 24 and/or the shutter 28. The power source 18 may comprise a DC and/or AC power source, and may optionally include one or more inverters, converters, and/or power conditioners. Optionally, one or more ballast circuits 30 may receive an electrical input from the power source 18 and convert it to a stable output for driving the projector system 16. One or more of the ballast circuits 30 may be positioned remotely from the projector system 16 or may be integral with or coupled directed to the housing 22 of the projector system 16.

The controller 20 may transmit one or more signals to control the operation of the illumination system 12. For example, the controller 20 may transmit a signal to the power source 18 in order to selectively energize one or more of the light engines 24. The controller 20 may also transmit a signal to the shutter 28 to selectively control the position of the shutter 28, for example, to select between high beam and/or low beam modes. The controller 20 may receive an input signal generated under the control of a user and/or generated from one or more sensors such as, but not limited to, an ambient light sensor or the like (not shown) and/or from another computer system (such as, but not limited to, a vehicle electronic control system (ECU)).

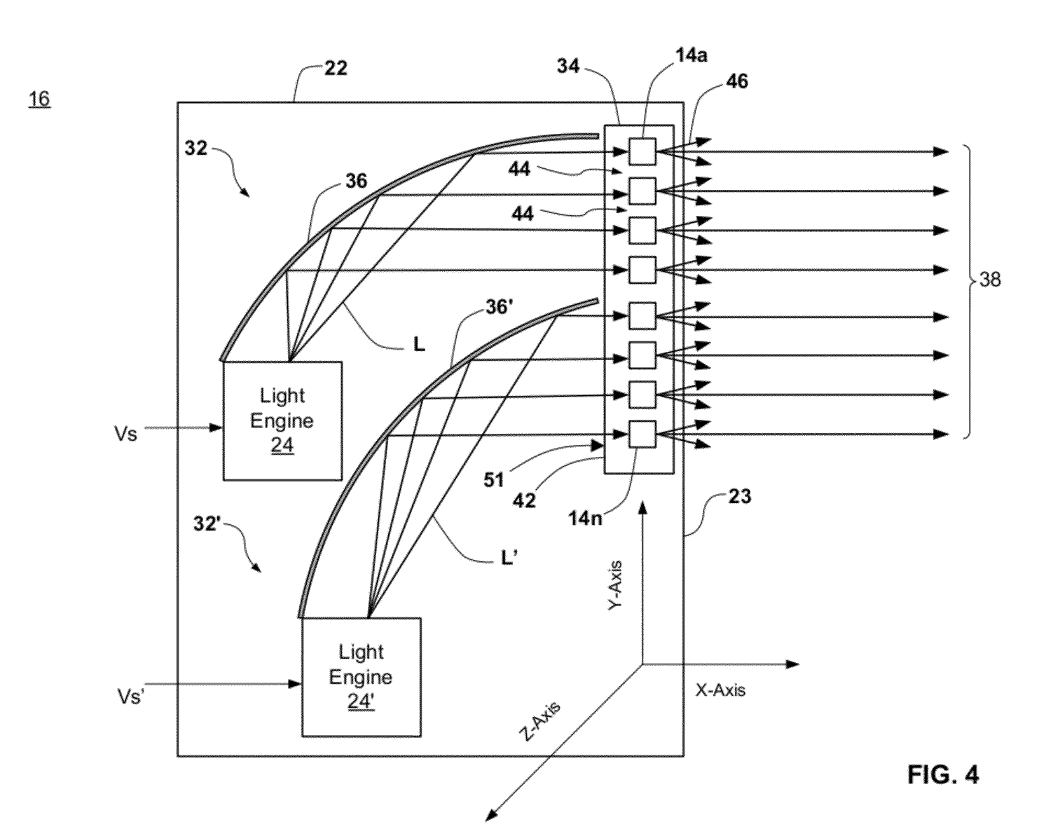

Turning now to FIG. 4, an exploded view of one embodiment of a projector system 16 is generally illustrated. The projector system 16 is shown without a shutter; however, it should be understood that the projector system 16 may include a shutter if desired. The projector system 16 includes at least one light assembly 32 and at least one discrete light assembly 34 having a plurality of discrete light lenses 14a-n. At least a portion of the light assembly 32 and/or the discrete light assembly 34 is received within the housing 22. For the sake of brevity, a single light assembly 32 and discrete light assembly 34 will be described; however, it will be appreciated that the projector system 16 may include more than one light assembly 32 and/or discrete light assembly 34.

The light assembly 32 includes at least one light engine 24 and at least one reflector 36. Light (generally indicated by arrows L) emitted from the light engine 24 is reflected by the reflector 36 to the discrete light assembly 34. A portion of the light L is then transmitted though the plurality of discrete light lenses 14a-n to create an illumination pattern 38 having the appearance of a plurality of individual light engines. The illumination pattern 38 may include, for example, a high beam pattern (in which light L from the projector system 16 is emitted above and below the horizon), a low beam pattern (in which light L from the projector system 16 is emitted generally only below the horizon), or the like.

The light engine 24 includes any known light source configuration such as one or more incandescent light source (such as, but not limited to, a halogen lamp), LEDs (with or without a remote phosphor element), a gas discharge light source such as a fluorescent tube (e.g., in a compact fluorescent (CFL) lamp), and/or a high-intensity discharge (HID) light source. While the light engine 24 is illustrated as a single light source, the light engine 24 may include multiple light sources depending on the application. For example, the light engine 24 may include multiple LEDs mounted on one or more printed circuit boards (PCBs).

As illustrated, the light engine 24 may emit light L in a direction generally perpendicular to the direction of the illumination pattern 38 and the reflector 36 is configured to redirect at least a portion of the light L generally towards the discrete light assembly 34. It should be appreciated, however, that the arrangement, shape and/or contour of the light engine 24 and the reflector 36 will depend on the specific application of the projector system 16 and may include (but is not limited to) such factors as the overall size constraints on the projector system 16, desired aesthetic appearance of the projector system 16, as well as the desired luminosity of the projector system 16.

The reflector 36 may be selected to have a high reflectivity. For example, the reflector 36 may have a reflectivity equal to or greater than 85%. The reflector 36 may also be selected from a material having a high thermal conductivity. In particular, the reflector 36 may be configured to reduce the junction temperature of the light engine 24 by conducting thermal energy from the light engine 24 and spreading the thermal energy across a greater area of the housing 22. For example, the reflector 36 may have a thermal conductivity, k, of 1.0 W/(m*K) or greater, 1.3 W/(m*K) or greater, 2.5 W/(m*K) or greater, 5.0 W/(m*K) or greater, 1.3-5.0 W/(m*K), 2.5-5.0 W/(m*K), 100 W/(m*K) or greater, for example, 200 W/(m*K) or greater. According to one embodiment, the reflector 36 may include a metal (such as, but not limited to, aluminum, copper, silver, gold, or the like), metal alloys, plastics (e.g., but not limited to, doped plastics), as well as composites. The thermal material may also be coated and/or layered with an optically reflective material to provide the desired reflectivity.

The discrete light assembly 34 includes a plurality of discrete light lenses 14a-n, wherein each of the plurality of discrete light lenses 14a-n is separated from an adjacent discrete light lens 14 by a border region 44. According to one embodiment, the plurality of discrete light lenses 14a-n may be mounted, coupled, or otherwise secured to a frame 42 of the discrete light assembly 34. For example, the frame 42 may include a plurality of channels (not shown for clarity) in which the discrete light lenses 14a-n may be mounted. Alternatively, the plurality of discrete light lenses 14a-n may be formed as a monolithic structure with the discrete light assembly 34.

The border regions 44 of the discrete light assembly 34 are configured to be opaque or generally opaque. As used herein, the term “opaque” is intended to mean that no light L emitted from the light engine 24 is emitted through the border region 44 while the term “generally opaque” is intended to mean that the border region 44 allows no more than 10% of the light L emitted from the light engine 24 is emitted through the border region 44. The border regions 44 may include portions of the frame 42 and/or portions of the monolithic discrete light assembly 34. For example, the border regions 44 may include a decorative trim and/or a mask, for example, which is black in color or which matches the color of the vehicle (FIGS. 1 and 2) proximate to the projector system 16.

As illustrated in FIG. 4, the projector system 16 may comprise additional light assemblies (generally indicated with by ′). In particular, each additional light assembly 32′ includes an associated light engine 24′ and an associated reflector 36′. According to one embodiment, a single discrete light assembly 34 is shared between light assembly 32 and light assembly 32′. In particular, the light engine 24 emits light L to the reflector 36 which redirects the light L to a first plurality of discrete light lenses 14a-n and the light engine 24′ emits light L′ to the reflector 36′ which redirects the light L′ to a second plurality of discrete light lenses 14a-n. Alternatively (or in addition), the projector system 16 may include a plurality of discrete light assemblies 34 (only one is shown) and each light assembly 32, 32′ may emit light L, L′ to only one of the discrete light assemblies 34.

For the sake of clarity, FIG. 4 includes an X, Y, Z coordinate system, wherein the Y-Axis corresponds to an axis extending parallel to the ground and extending left and right across vehicle, the X-Axis corresponds to an axis extending parallel to the ground and extending fore and aft across vehicle, and the Z-Axis corresponds to an axis extending perpendicular to the ground (each of the X, Y, and Z axes are perpendicular to each other). The discrete light lenses 14a-n may be arranged in one or more patterns along the X, Y, and/or Z axes to create an aesthetically pleasing appearance. For example, a plurality of the discrete light lenses 14a-n may be arranged along the X, Y, and/or Z axes to create a visual “wave” (e.g., at least a portion of a sinusoidal wave or the like). A plurality of the discrete light lenses 14a-n may also be arranged generally vertically (i.e., generally along the Z-axes) and/or may be arranged generally horizontally (i.e., generally along the Y-axis). The vertical and/or horizontal discrete light lenses 14a-n may optionally be staggers along the X-axis, for example, to conform to the contours of the vehicle or the like.

According to one embodiment, the plurality of discrete light lenses 14a-n do not generally alter the direction of the light L reflected from the reflector 36. In particular, the plurality of discrete light lenses 14a-n may generally allow the light L from the reflector 36 to pass straight through the discrete light lenses 14a-n. In this case, the illumination pattern 38 is generated by the reflector 36, and the plurality of discrete light lenses 14a-n only function to create an appearance of a plurality of individual, discrete light engines. Alternatively (or in addition), at least one of the plurality of discrete light lenses 14a-n may be configured to focus the light L emitted from the projector system 16 to create and/or aid in the formation of the at least a portion of the illumination pattern 38. Furthermore, at least one of the plurality of discrete light lenses 14a-n may redirect a portion of the light L emitted from the projector system 16 (generally illustrated by arrows 46) to create a jeweled, brilliant appearance. In particular, a portion of a discrete light lens 14a may be configured to create a desired amount of external and/or internal brilliance (i.e., the amount of incident light reflected back to the viewer). A portion of a discrete light lens 14a may also be configured to create a desired amount of dispersive power (i.e., the ability of the lens 14a to split white light into its component spectral colors). While not a limitation of the present disclosure unless specifically claimed as such, dispersion may be particularly useful for use with emergency vehicles. Dispersion may also be useful for creating aesthetically pleasing effects.

The discrete light lenses 14a-n may have any shape depending on the desired aesthetic appearance. For example, one or more of the discrete light lenses 14a-n may have a generally square cross-section, a generally circular cross-section, a generally oval cross-section, a generally rectangular cross-section, or the like. A discrete light lens 14a having a square cross-section may have an appearance similar to the “ice-cube” associated with expensive headlights which have an individual LED for each discrete light source. The discrete light lenses 14a-n may also have a convex, concaved, or aspherical configuration which may be configured to focus the light to form the illumination pattern 38 and/or diffuse a portion of the light L 46 to form the jeweled, brilliant appearance discussed herein.

The reflector 36 may be configured to reflect the light L emitted from the light engine 24 generally only through the discrete light lenses 14a-n. In particular, the reflector 36 may be configured to aim the light L through the discrete light lenses 14a-n and generally not at the border region 44. Such an arrangement may increase the efficiently of the projector system 16 and allow a smaller light engine 24 (i.e., lower wattage) while achieving a desired luminosity. Alternatively, the reflector 36 may be configured to reflect the light L emitted from the light engine 24 generally evenly across the inner surface 51 of the discrete light assembly 34. Such an arrangement may be less complex and easier/cheaper to manufacture.

Optionally, the projector system 16 may include an outer lens 23. The outer lens 23 may be provided to increase the aerodynamics of the projector system 16. For example, the outer lens 23 may allow the projector system 16 to aerodynamically blend in with the adjacent portions of the vehicle to reduce aerodynamic drag. The outer lens 23 may also be configured to protect the plurality of discrete light lenses 14a-n from debris and the like.

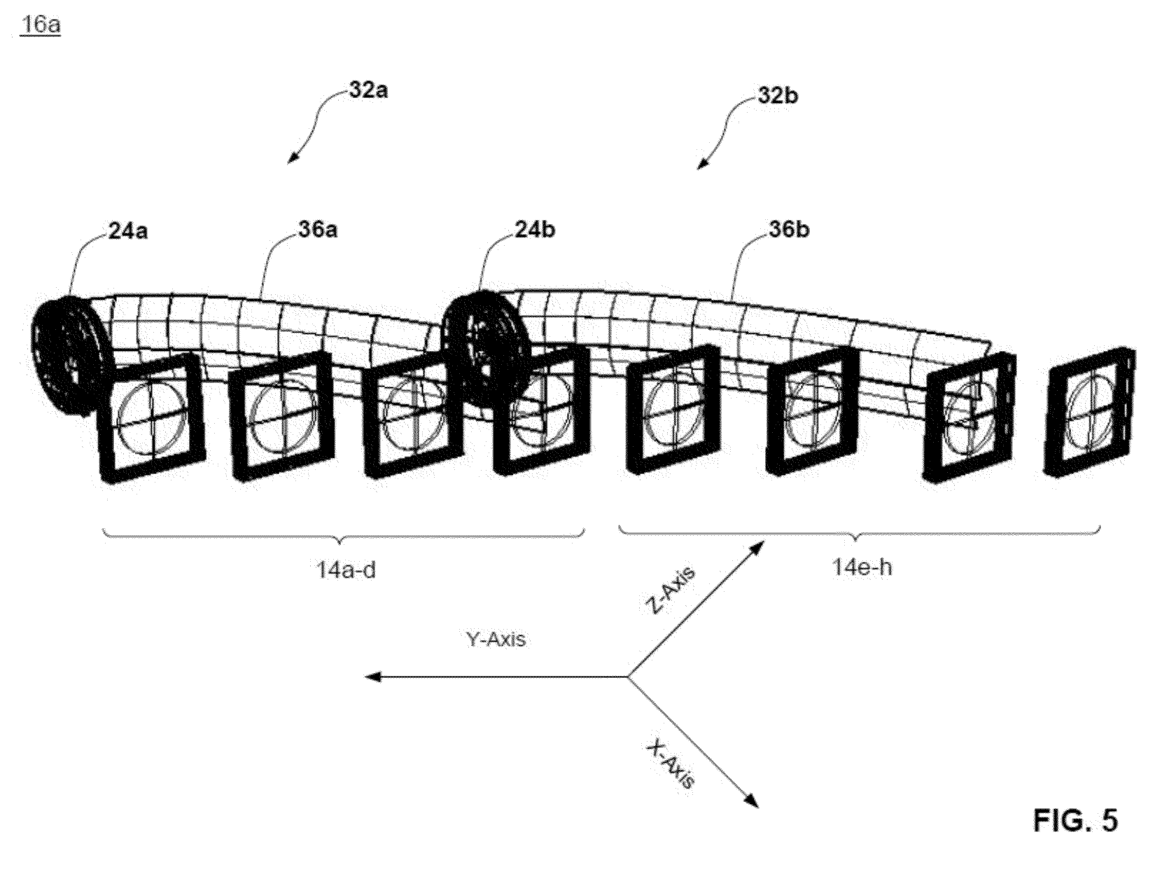

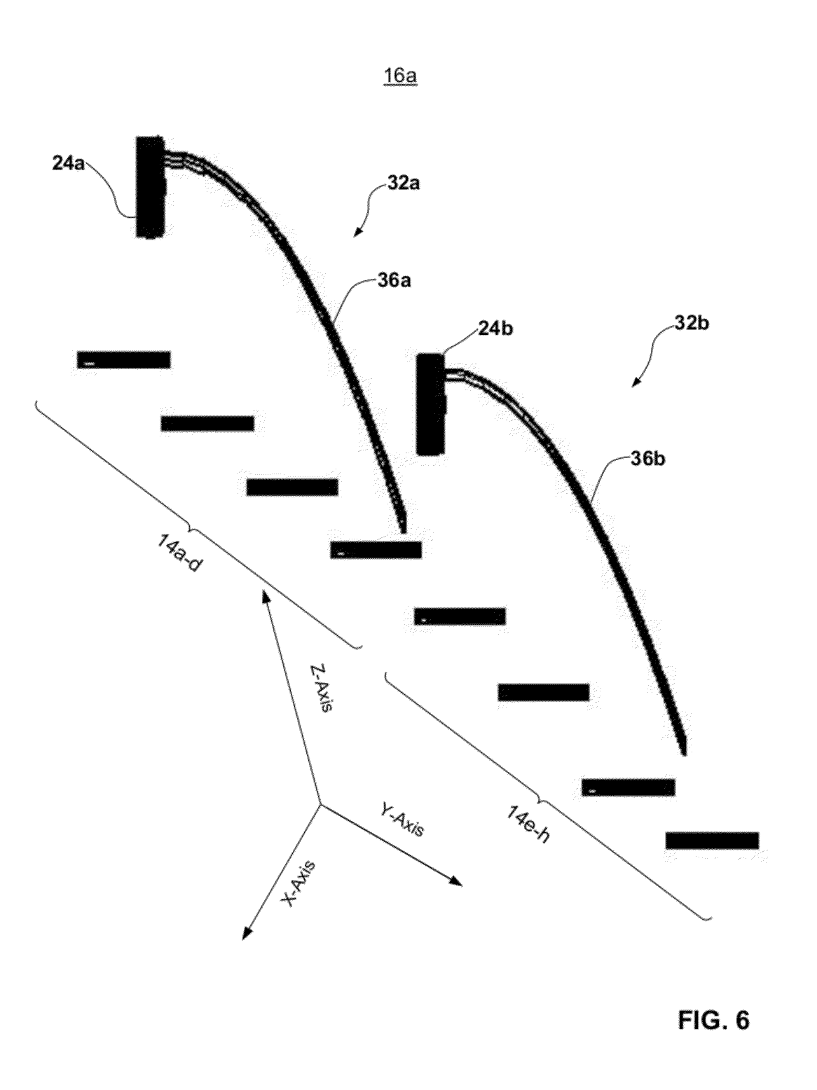

Turning now to FIGS. 5 and 6, a perspective front and top view of one embodiment of a projector system 16a is generally illustrated (note, the housing has been eliminated for clarity). As can be seen, the projector system 16a includes a first and a second light assembly 32a, 32b. The first light assembly 32a includes a first light engine 24a which emits light towards a first reflector 36a. The first reflector 36a redirects the light from the first light engine 24a through a first plurality of discrete light lenses 14a-d. As can be seen, the first plurality of discrete light lenses 14a-d extend along the Y-axis in the same Z-axis, but are staggered along the X axis. Similarly, the second light assembly 32b includes a second light engine 24b which emits light towards a second reflector 36b. The second reflector 36b redirects the light from the second light engine 24b through a second plurality of discrete light lenses 14e-h. As can be seen, the second plurality of discrete light lenses 14e-h extend along the Y-axis in the same Z-axis, but are staggered along the X axis. The plurality of discrete light lenses 14a-h each have a generally square cross-section which is slightly domed (e.g., having approximately a 10 degree compound).

Simulations were performed using the projector system 16a of FIGS. 5 and 6. In particular, JFL2 LEDs (commercially available from Osram Sylvania, Inc., the assignees of the instant disclosure) were selected for the light engines 24a, 24b. The total lumens produced by the projector system 16a were approximately 850 μm warm. The reflectors 36a, 36b were selected to be 39 mm×120 mm having an 85% reflectivity. The outer lens 23 (not shown for clarity) was selected be to 40 degrees. The plurality of discrete light lenses 14a-n were selected from acrylic material and were selected to have 40 mm×40 mm overall external dimensions and to have a slightly domed (approximately 10 degree compound) shape. The normal correction factor for 85% reflective reflector 36 and a 40 degree compound outer lens 23 is 70%. Adding the plurality of discrete light lenses 14a-n results in approximately 93% transmission. Each discrete light lenses 14a-n was selected to be surrounded by a 2 mm wide frame 42 (not shown for clarity), which blocks 11% of the area, resulting in an 89% transmission (the area of each discrete light lenses 14a-n is 0.0001331, and the area of the frame 42 is 0.0000164). Multiplying the 70% correction factor by the 93% correction factor by the 89% correction factor results in a 58% overall correction factor.

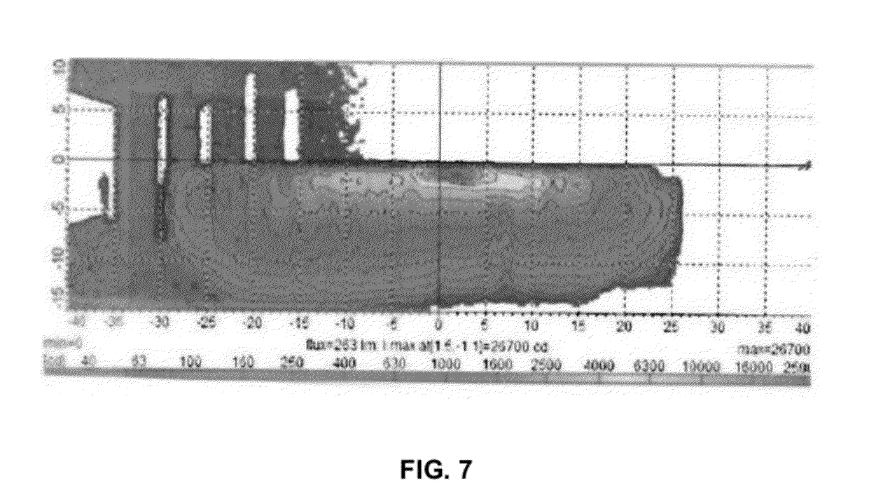

FIGS. 7-10 illustrate various simulation results for one embodiment of a projector system consistent with FIGS. 5 and 6 above. The simulations were performed using LucidShape™ made by Brandenburg, Germany. In particular, Table 1 below shows the predicted simulation results generated by the simulation program for a low beam mode of the projector system based on the FMCSS 108 low beam requirements for the United States of America.

TABLE 1
Date:
Scale: 1
LID name: LID; scale = 0.59
Regulation: FMVSS 108 Tab. XIX-a LB2V lower bean VOL/VOR

| | value OK | min | max | test pos./area H, | found pos. |
|---|---|---|---|---|---|
| name | [cd] | [cd] | [cd] | H/V, V [deg] | [deg.] |
| 10U-90U | 0.00 OK | — | 125.0 | 0.0, 0.0/10.0, 90.0 | 0.1, 9.9 |
| 4U 8L | 22.49 ?? | 64.00 | — | −8.0, 4.0 | |
| 4U 8R | 0.00 ?? | 64.00 | — | 8.0, 4.0 | |
| 2U 4L | 8.30 ?? | 135.0 | — | −4.0, 2.0 | |
| 1.5U 1R-3R | 0.00 ?? | 200.0 | — | 1.0, 3.0/1.5, 1.5 | 1.1, 1.5 |
| 1.5U 1R-R | 0.00 OK | — | 1400.0 | 1.0, 20.0/1.5, 1.5 | 1.1, 1.5 |
| 1.0U 1.5L-L | 52.30 OK | — | 700.0 | −20.0, −1.5/1.0, 1.0 | −18.1, 1.1 |
| 0.5U 1.5L-L | 58.41 OK | — | 1000.0 | −20.0, −1.5/0.5, 0.5 | −17.9, 0.5 |
| 0.5U 1R-3R MAX | 0.00 OK | — | 2700.0 | 1.0, 3.0/0.5, 0.5 | 1.3, 0.5 |
| 0.5U 1R-3R MIN | 0.00 ?? | 500.0 | — | 1.0, 3.0/0.5, 0.5 | 1.7, 0.5 |
| H 4L | 166.6 OK | 135.0 | — | −4.0, 0.0 | |
| H 8L | 169.1 OK | 64.00 | — | −8.0, 0.0 | |
| 0.6D 1.3R | 17052 OK | 10000 | — | 1.3, −0.6 | |
| 0.86D V | 18547 OK | 4500.0 | — | 0.0, −0.9 | |
| 0.86D 3.5L | 3140.5 OK | 1800.0 | 12000 | −3.5, −0.9 | |
| 1.5D 2R | 20854 OK | 15000 | — | 2.0, −1.5 | |
| 2 D 9 L | 3803.8 OK | 1250.0 | — | −9.0, −2.0 | |
| 2 D 9 R | 4810.5 OK | 1250.0 | — | 9.0, −2.0 | |
| 2 D 15R | 2421.8 OK | 1000.0 | — | 15.0, −2.0 | |
| 2 D 15L | 2146.6 OK | 1000.0 | — | −15.0, −2.0 | |
| 4 D 4 R | 2234.9 OK | — | 12500 | 4.0, −4.0 | |
| 4 D 20L | 1360.3 OK | 300.0 | — | −20.0, −4.0 | |
| 4 D 20R | 653.0 OK | 300.0 | — | 20.0, −4.0 | |
| grad 2.5L | 0.76 OK | 0.13 | — | −2.5, −2.5/−1.5, 1.5 | −2.5, −0.1 |
| grad 2R | 1.04 OK | 0.13 | — | 2.0, 2.0/−1.5, 1.5 | 2.1, −0.1 |

The light intensity distribution is NOT OK

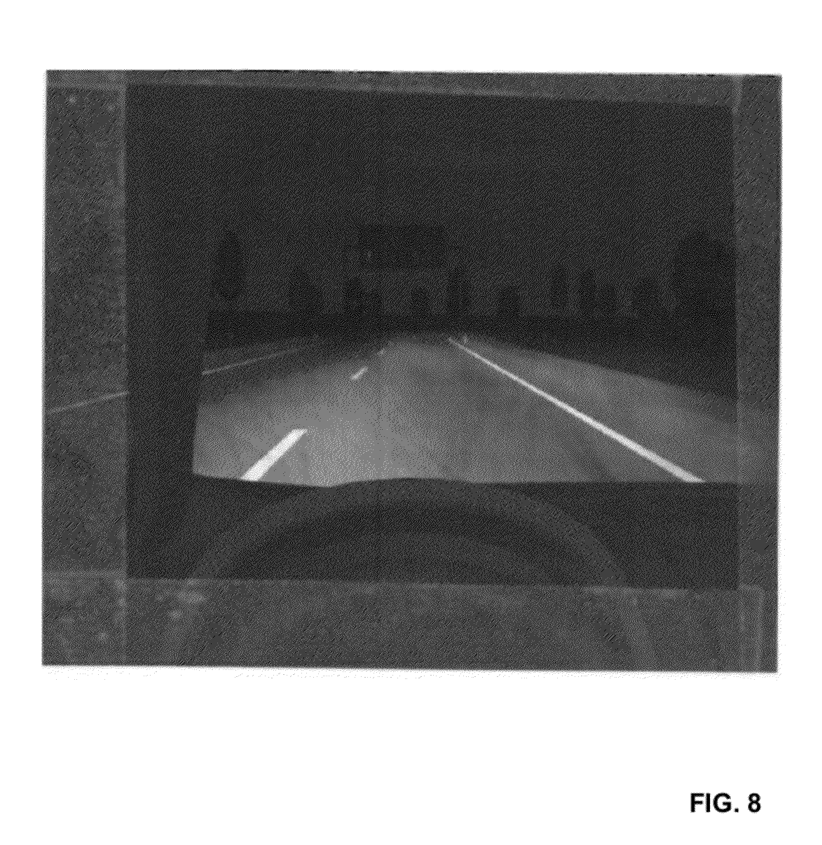

FIG. 7 illustrates a predicted isocandela plot for the projector system corresponding to the predicted simulation results of Table 1. FIG. 8 illustrates a computer generated road view illustrating the illumination pattern 38 of the projector system. While certain test points used to illuminate overhead signs do not pass, these points were intentionally ignored for these simulations as it is generally easy to find stray light from tooled parts and to add the sign light later (i.e., it is generally easy to add this light whereas it is generally difficult to subtract it if necessary). In addition, while a small amount of streaks in the simulated road scene may be seen, this is a result of the frames and is considered to be acceptable as actual production projector systems will likely have an increased amount of stray light which will minimize the appearance of the streaks (i.e., the simulation will likely look worse than the actual projector system).

Tables 2 and 3 (below) show the predicted simulation results for a low and a high beam mode, respectively, of another embodiment of a projector system consistent with the present disclosure.

TABLE 2
Date:
Scale: 1
LID name: LID; scale = 0.59
Regulation: FMVSS 108 Tab. XIX-a LB2V lower bean VOL/VOR

| | value OK | min | max | test pos./area H, | found pos. |
|---|---|---|---|---|---|
| name | [cd] | [cd] | [cd] | H/V, V [deg] | [deg] |
| 10U-90U | 0.00 OK | — | 125.0 | 0.0, 0.0/10.0, 90.0 | 0.1, 9.9 |
| 4U 8L | 26.79 ?? | 64.00 | — | −8.0, 4.0 | |
| 4U 8R | 0.00 ?? | 64.00 | — | 8.0, 4.0 | |
| 2U 4L | 11.38 ?? | 135.0 | — | −4.0, 2.0 | |
| 1.5U 1R-3R | 0.00 ?? | 200.0 | — | 1.0, 3.0/1.5, 1.5 | 1.1, 1.5 |
| 1.5U 1R-R | 0.00 OK | — | 1400.0 | 1.0, 20.0/1.5, 1.5 | 1.1, 1.5 |
| 1.0U 1.5L-L | 68.27 OK | — | 700.0 | −20.0, −1.5/1.0, 1.0 | −19.3, 1.1 |
| 0.5U 1.5L-L | 60.44 OK | — | 1000.0 | −20.0, −1.5/0.5, 0.5 | −19.9., 0.5 |
| 0.5U 1R-3R MAX | 0.00 OK | — | 2700.0 | 1.0, 3.0/0.5, 0.5 | 2.5, 0.5 |
| 0.5U 1R-3R MIN | 0.00 ?? | 500.0 | — | 1.0, 3.0/0.5, 0.5 | 1.1, 0.5 |
| H 4L | 204.3 OK | 135.0 | — | −4.0, 0.0 | |
| H 8L | 200.4 OK | 64.00 | — | −8.0, 0.0 | |
| 0.6D 1.3R | 18731 OK | 10000 | — | 1.3, −0.6 | |
| 0.86D V | 20007 OK | 4500.0 | — | 0.0, −0.9 | |
| 0.86D 3.5L | 3554.6 OK | 1800.0 | 12000 | −3.5, −0.9 | |
| 1.5D 2R | 21350 OK | 15000 | — | 2.0, −1.5 | |
| 2 D 9 L | 4150.5 OK | 1250.0 | — | −9.0, −2.0 | |
| 2 D 9 R | 5442.8 OK | 1250.0 | — | 9.0, −2.0 | |
| 2 D 15R | 2395.6 OK | 1000.0 | — | 15.0, −2.0 | |
| 2 D 15L | 2479.7 OK | 1000.0 | — | −15.0, −2.0 | |
| 4 D 4 R | 2247.5 OK | — | 12500 | 4.0, −4.0 | |
| 4 D 20L | 1495.8 OK | 300.0 | — | −20.0, −4.0 | |
| 4 D 20R | 682.0 OK | 300.0 | — | 20.0, −4.0 | |
| grad 2.5L | 0.68 OK | 0.13 | — | −2.5, −2.5/−1.5, 1.5 | −2.5, −0.1 |
| grad 2R | 0.99 OK | 0.13 | — | 2.0, 2.0/−1.5, 1.5 | 2.1, −0.1 |

The light intensity distribution is NOT OK

TABLE 3
Date:
Scale: 1
LID name: LID; scale = 0.59
Regulation: FMVSS 108 Tab. XVIII UB2 upper bean

| | | | | test pos./area | |
|---|---|---|---|---|---|
| | value OK | min | max | H, H/V, V | found pos. |
| name | [cd] | [cd] | [cd] | [deg] | [deg] |
| 2U V | 3281.0 OK | 1500.0 | — | 0.0, 2.0 | |
| 1U 3R | 15914 OK | 5000.0 | — | 3.0, 1.0 | |
| 1U 3L | 10284 OK | 5000.0 | — | −3.0, 1.0 | |
| HV | 69079 OK | 40000 | 75000 | 0.0, 0.0 | |
| Emax | 69483 OK | — | — | | 0.1, −0.1 |
| H 3R | 24058 OK | 15000 | — | 3.0, 0.0 | |
| H 3L | 24893 OK | 15000 | — | −3.0, 0.0 | |
| H 6L | 8777.6 OK | 5000.0 | — | −6.0, 0.0 | |
| H 6R | 8509.2 OK | 5000.0 | — | 6.0, 0.0 | |
| H 9R | 5847.6 OK | 3000.0 | — | 9.0, 0.0 | |
| H 9L | 5536.3 OK | 3000.0 | — | −9.0, 0.0 | |
| H 12L | 4097.6 OK | 1500.0 | — | −12.0, 0.0 | |
| H 12R | 3794.7 OK | 1500.0 | — | 12.0, 0.0 | |
| 1.5D V | 19102 OK | 5000.0 | — | 0.0, −1.5 | |
| 1.5D 9R | 8567.3 OK | 2000.0 | — | 9.0, −1.5 | |
| 1.5D 9L | 7216.4 OK | 2000.0 | — | −9.0, −1.5 | |
| 2.5D V | 6118.0 OK | 2500.0 | — | 0.0, −2.5 | |
| 2.5D 12R | 4761.6 OK | 1000.0 | — | 12.0, −2.5 | |
| 2.5D 12L | 4340.3 OK | 1000.0 | — | −12.0, −2.5 | |
| 4D V | 2715.3 OK | — | 12000 | 0.0, −4.0 | |

The light intensity distribution is OK

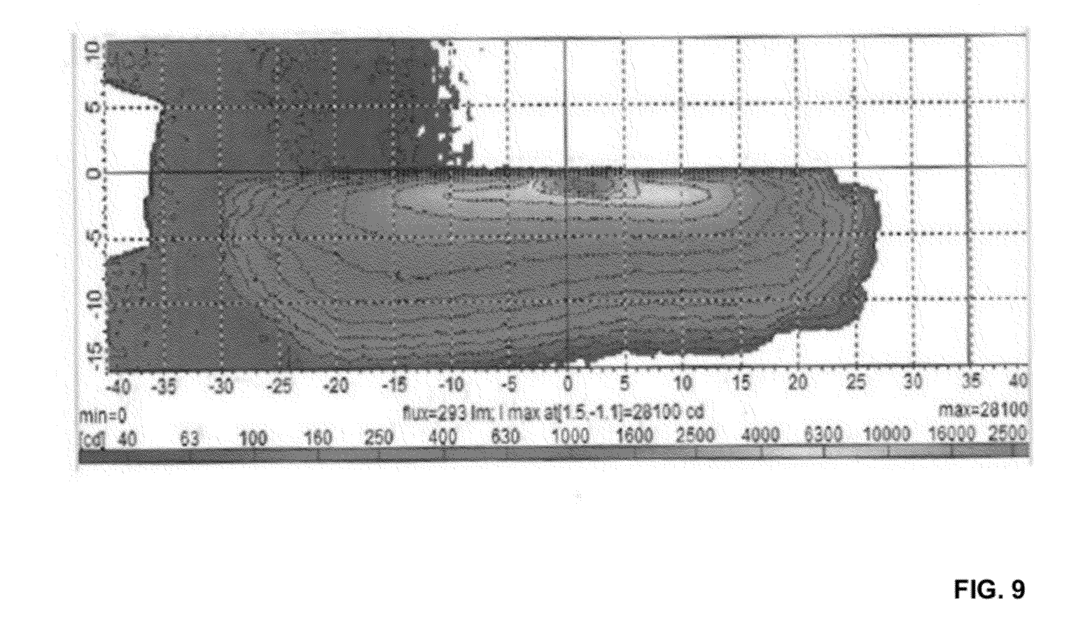

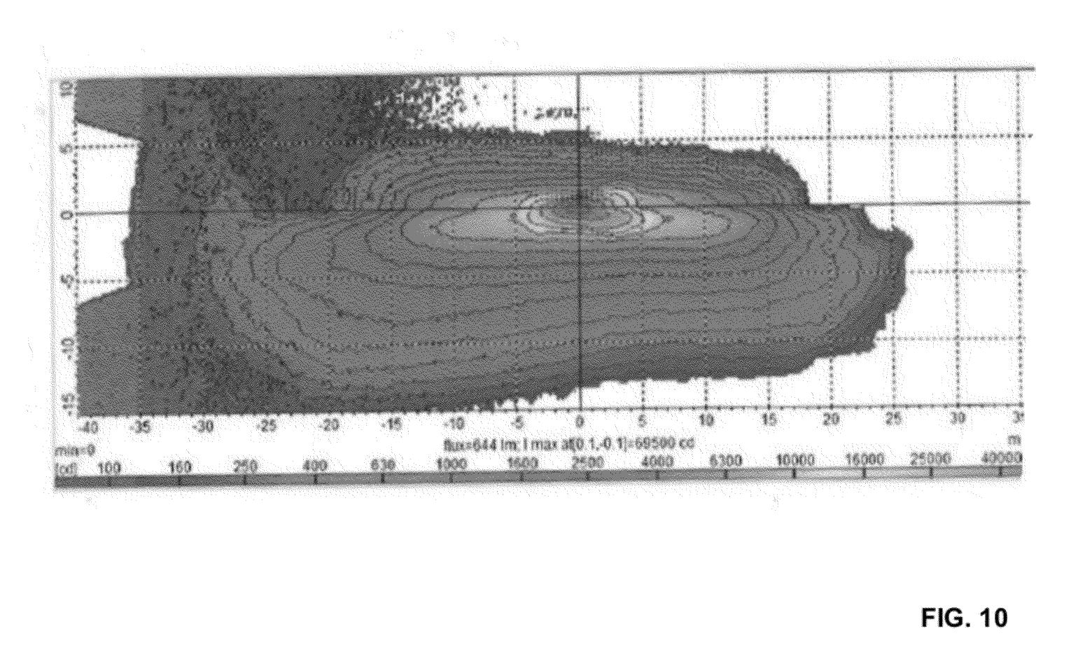

FIGS. 9 and 10 illustrate predicted isocandela plots corresponding to the predicted simulation results of Tables 2 and 3, respectively. These simulations were performed without frames and were used to successfully establish the initial concept.

The following is a list of reference numeral used in the specification:
10 vehicle;
12a-n illumination systems;
14a-n discrete light lenses;
16, 16a projector system;
18 power source;
20 controller;
22 housing;
23 outer lens;
24, 24a, 24b light engine;
28 shutter;
30 ballast circuits;
32, 32a, 32b light assembly;
34 discrete light assembly;
36, 36a, 36b reflector;
38 illumination pattern;
42 frame;
44 regions;
46 portion of the light L;
51 inner surface.

According to a one aspect, the present disclosure features a projector system. The projector system includes a discrete light assembly and a first reflector. The discrete light assembly includes a first plurality of discrete light lenses, wherein each of the first plurality of discrete light lenses is separated from an adjacent discrete light lens by a first border region which is generally opaque. The first reflector is configured to reflect light emitted from a first light engine through the first plurality of discrete light lenses. Light emitted from the first light engine is emitted from the first plurality of discrete light lenses such that each of the first plurality of discrete light lenses appears to be associated with individual light engines.

The projector system may optionally include a second plurality of discrete light lenses and a second reflector. Each of the second plurality of discrete light lenses is separated from an adjacent discrete light lens by a second, generally opaque border region. The second reflector is configured to reflect light emitted from a second light engine through the second plurality of discrete light lenses. Light emitted from the second light engine is emitted from the second plurality of discrete light lenses such that each of the second plurality of discrete light lenses appears to be associated with individual light engines.

According to another aspect, the present disclosure features an illumination system including a light engine, a projector system, and optionally a controller. The projector system includes a discrete light assembly and a reflector. The discrete light assembly includes a plurality of discrete light lenses, wherein each of the plurality of discrete light lenses is separated from an adjacent discrete light lens by a border region which is generally opaque. The reflector is configured to reflect light emitted from the light engine through the plurality of discrete light lenses. The controller is configured to selectively energize the light engine. Light emitted from the light engine is emitted from the plurality of discrete light lenses such that each of the plurality of discrete light lenses appears to be associated with individual light engines.

According to yet another aspect, the present disclosure features method including emitting light from a light engine; reflecting light emitted from the light engine to a discrete light assembly, the discrete light assembly having a plurality of discrete light lenses, wherein each of the plurality of discrete light lenses is separated from an adjacent discrete light lens by a border region which is generally opaque; and emitting the reflected light through the plurality of discrete light lenses such that the light emitted from each of the plurality of discrete light lenses appears to be associated with individual light engines; wherein the generally opaque border region blocks a portion of the reflected light from being emitted through the plurality of discrete light lenses.

The terms “first,” “second,” “third,” and the like herein do not denote any order, quantity, or importance, but rather are used to distinguish one element from another, and the terms “a” and “an” herein do not denote a limitation of quantity, but rather denote the presence of at least one of the referenced item.

While the principles of the present disclosure have been described herein, it is to be understood by those skilled in the art that this description is made only by way of example and not as a limitation as to the scope of the invention. The features and aspects described with reference to particular embodiments disclosed herein are susceptible to combination and/or application with various other embodiments described herein. Such combinations and/or applications of such described features and aspects to such other embodiments are contemplated herein. Other embodiments are contemplated within the scope of the present invention in addition to the exemplary embodiments shown and described herein. Modifications and substitutions by one of ordinary skill in the art are considered to be within the scope of the present invention.

1. A projector system (16) comprising:
a discrete light assembly (34) having a plurality of discrete light lenses (14a-n), wherein each of said plurality of discrete light lenses (14a-n) is separated from an adjacent discrete light lens by a border region (44), wherein said border region (44) is generally opaque; and
a reflector (36) configured to reflect light emitted from a light engine (24) through said plurality of discrete light lenses (14a-n);
wherein light (L) emitted from said light engine (24) is emitted from said plurality of discrete light lenses (14a-n) such that each of said plurality of discrete light lenses (14a-n) appears to be associated with individual light engines.

2. The projector system of claim 1, wherein said border region (44) is opaque.

3. The projector system of claim 1, wherein said discrete light assembly (34) further comprises a frame (42) configured to secure said plurality of discrete light lenses (14a-n), wherein said frame (42) includes said border (44) region between adjacent discrete light lenses (14a-n).

4. The projector system of claim 1, wherein said discrete light assembly (34) is a monolithic component comprising said plurality of discrete light lenses (14a-n).

5. The projector system of claim 1, wherein said border region (44) comprises at least one mask disposed between adjacent discrete light lenses (14a-n).

6. The projector system of claim 1, wherein said light engine (24) comprises a light emitting diode (LED).

7. An illumination system (12) comprising:
a light engine (24) including at least one light emitting diode (LED);
a projector system (16) comprising:
a discrete light assembly (34) having a plurality of discrete light lenses (14a-n), wherein each of said plurality of discrete light lenses (14a-n) is separated from an adjacent discrete light lens by a border region (44), wherein said border region (44) is generally opaque; and
a reflector (36) configured to reflect light (L) emitted from said light engine (24) through said plurality of discrete light lenses (14a-n); and
wherein light (L) emitted from said light engine (24) is emitted from said plurality of discrete light lenses (14a-n) such that each of said plurality of discrete light lenses (14a-n) appears to be associated with individual light engines.

8. The illumination system of claim 7, wherein said border region (44) is opaque.

9. The illumination system of claim 7, wherein said discrete light assembly (34) further comprises a frame (42) configured to secure said plurality of discrete light lenses (14a-n), wherein said frame (42) includes said border region (44) between adjacent discrete light lenses (14a-n).

10. The illumination system of claim 7, wherein said discrete light assembly (34) is a monolithic component comprising said plurality of discrete light lenses (14a-n).

11. The illumination system of claim 7, wherein said border region (44) comprises at least one mask disposed between adjacent discrete light lenses (14a-n).

12. A method comprising:
emitting light (L) from a light engine (24);
reflecting light (L) emitted from said light engine (24) to a discrete light assembly (34), said discrete light assembly (34) having a plurality of discrete light lenses (14a-n), wherein each of said plurality of discrete light lenses (14a-n) is separated from an adjacent discrete light lens by a generally opaque border region (44);
emitting said reflected light (L) through said plurality of discrete light lenses (14a-n) such that said light (L) emitted from each of said plurality of discrete light lenses (14a-n) appears to be associated with individual light engines; and
blocking a portion of said reflected light (L) from being emitted through said plurality of discrete light lenses (14a-n) with said generally opaque border region (44).

13. The method of claim 12, wherein said discrete light assembly (34) further comprises a frame (42) configured to secure said plurality of discrete light lenses (14a-n), and wherein said frame (42) blocks said portion of said reflected light (L) from being emitted through said plurality of discrete light lenses (14a-n).

14. The method of claim 12, wherein said discrete light assembly (34) is a monolithic components comprising said plurality of discrete light lenses (14a-n).

15. The method of claim 12, wherein said border region (44) is opaque.
